(19) United States
(12) Patent Application Publication
(10) Pub. No.: US 2017/0076216 A1
(43) Pub. Date: Mar. 16, 2017

(54) MAINTENANCE EVENT PLANNING USING ADAPTIVE PREDICTIVE METHODOLOGIES

(71) Applicant: Siemens Aktiengesellschaft, Munich (DE)

(72) Inventors: Ioannis Akrotirianakis, Princeton, NJ (US); Amit Chakraborty, East Windsor, NJ (US); Jie Liu, Bethlehem, PA (US)

(21) Appl. No.: 14/849,649

(22) Filed: Sep. 10, 2015

(51) Int. Cl. G06N 7/00; G06F 9/48

(52) U.S. Cl. CPC G06N 7/005; G06F 9/4881

(57) ABSTRACT

A generalized autoregressive integrated moving average (ARIMA) model for use in predictive analytics of time series is based upon creating all possible ARIMA models (by knowing a priori the largest possible values of the p, d and q parameters forming the model), and utilizing the results of at least two different performance measures to ultimately choose the ARIMA(p,d,q) model that is most appropriate for the time series under study. The method of the present invention allows each parameter to range over all possible values, and then evaluates the complete universe of all possible ARIMA models based on these combinations of p, d and q to find the specific p, d and q parameters that yield the “best” (i.e., lowest value) performance measure results. This generalized ARIMA model is particularly useful in predicting future operating hours of power plants and scheduling maintenance events on the gas turbines at these plants.

### TECHNICAL FIELD

The present invention relates to methodologies for analyzing time series data and, more particularly, to providing predictive time series trends in a manner useful for planning purposes, such as scheduling maintenance events.

### BACKGROUND

Predictive analytics of time series is an important component in many business decisions, where the ability to predict future events at a relatively high level of certainty often results in better outcomes (i.e., utilization of resources, inventory control, financial planning, etc.). In the power plant industry, for example, predictive analytics is used to schedule out-of-service maintenance events based on the past hours of operation of the plant (i.e., the “time series”). The past operating hours of a power plant is an important factor in predicting future operating hours and, therefore, is useful in optimizing the scheduling of maintenance events (i.e., scheduling maintenance events during “off peak” hours). With respect to gas turbines in particular, there are mainly three types of maintenance inspections: (1) standby inspections, (2) running inspections, and (3) disassembly inspections. The standby inspection is performed during off-peak periods when the unit is not operating and includes routine servicing of accessory systems and device calibration. This inspection is performed when the turbine is “available” but is not in service at that moment. The running inspection, as its name indicates, is performed by observing key operating parameters while the turbine is running. This leaves the category of “disassembly inspections” as those where care is needed in scheduling the maintenance events, since the turbine needs to be shut down as they are performed, thus creating a period of time where the turbines cannot produce energy for their customers.

Forecasting problems regarding power consumption have been investigated for a long time. Popular methods in time series forecasting for power systems include growth curve models, multiple linear regression models, autoregressive integrated moving average (ARIMA) models and wavelet models. One model, the naïve ARIMA, uses a set of quality parameters (such as the autocorrelation function (ACF) and partial autocorrelation function (PCF), or one of the known “information criteria” such as the Akaike Information Criterion (AIC)) to select an acceptable model.

While relatively simple to use, the naïve ARIMA methods of times series forecasting have not always been successful in properly forecasting various types of time series, lacking the ability to discover and consider sporadic events.

### SUMMARY OF THE INVENTION

The needs remaining in the prior art are addressed by the present invention, which relates to methodologies to analyzing time series data and, more particularly, to providing predictive time series trends in a manner useful for planning purposes, such as electricity demand forecasting, power plant operating hours forecasting, scheduling power plant maintenance events, and the like.

Instead of relying on a naïve ARIMA model selected by using ACF/PCF or AIC, the method of the present invention evaluates the universe of all possible ARIMA models and ranks their performance based upon one or more different performance measures. Depending on the specific performance measures used, specific (p,d,q) sets of parameters may be defined as optimum for forecasting future values of a given time series.

In one exemplary embodiment, a set of wavelet-ARIMA models may be included in the analysis, particularly useful when the time series being analyzed is non-stationary.

In accordance with the present invention, this generalized ARIMA methodology allows for a better fit of a model for a particular time series, since each series is unique. When used in scheduling maintenance events for gas turbines, the specific conditions of each turbine (as indicated by its unique time series) allows for an optimum maintenance schedule to be developed for each specific turbine.

In one embodiment, the present invention takes the form of a method of scheduling events for industrial equipment using an autoregressive integrated moving average (ARIMA) model for predicting future operating hours based on a times series of past operating hours of the industrial equipment, comprising the steps of: (1) defining a maximum possible value for each parameter p, d, q of an ARIMA(p,d,q) model, p defining a number of autoregressive terms to include in the ARIMA model, d defining a number of differencing operations to perform in the ARIMA model, and q defining a number of moving average terms to include in the ARIMA model, the maximum possible values identified as pᵣ, dᵣ, and qᵣ; (2) for all possible combinations of p from 0 to pᵣ, d from 0 to dᵣ, and q from 0 to qᵣ, performing the following steps: (a) determining a set of ARIMA coefficients associated with a training interval of the time series; (b) predicting a set of N future hours based on the determined coefficients; (c) computing at least one performance measure of the predicted set of N future operating hours with respect to actual time series data; and (d) ranking all possible combinations of ARIMA(p,d,q) based on the computed performance measures, followed by: (3) selecting a preferred set of (p, d, q) parameters based on the ranking; (4) generating a predicted future time series of industrial operating hours using the selected ARIMA(p,d,q) model; and (5) scheduling events based on the predicted future operating hours.

In another embodiment, the present invention comprises a computer program product comprising a non-transitory computer readable recording medium having recorded thereon a computer program comprising instructions for, when executed on a computer, instructing said computer to perform a method for scheduling events associated with industrial equipment, using an autoregressive integrated moving average (ARIMA) model for predicting future operating hours based on past operating hours of the industrial equipment, comprising the steps of: (1) defining a maximum possible value for each parameter p, d, q of an ARIMA(p,d,q) model, p defining a number of autoregressive terms to include in the ARIMA model, d defining a number of differencing operations to perform in the ARIMA model, and q defining a number of moving average terms to include in the ARIMA model, the maximum possible values identified as pᵣ, dᵣ, and qᵣ; (2) for all possible combinations of p from 0 to pᵣ, d from 0 to dᵣ, and q from 0 to qᵣ, performing the following steps: (a) determining a set of ARIMA coefficients associated with a training interval of the time series; (b) predicting a set of N future hours based on the determined coefficients; (c) computing at least one performance measure of the predicted set of N future operating hours with respect to actual time series data; and (d) ranking all possible combinations of ARIMA(p,d,q) based on the computed performance measures, followed by: (3) selecting a preferred set of (p, d, q) parameters based on the ranking; (4) generating a predicted future time series of industrial operating hours using the selected ARIMA(p,d,q) model; and (5) scheduling events based on the predicted future operating hours.

Other and further embodiments and features of the present invention will become apparent during the course of the following discussion and by reference to the accompanying drawings.

### BRIEF DESCRIPTION OF THE INVENTION

Referring now to the drawings,

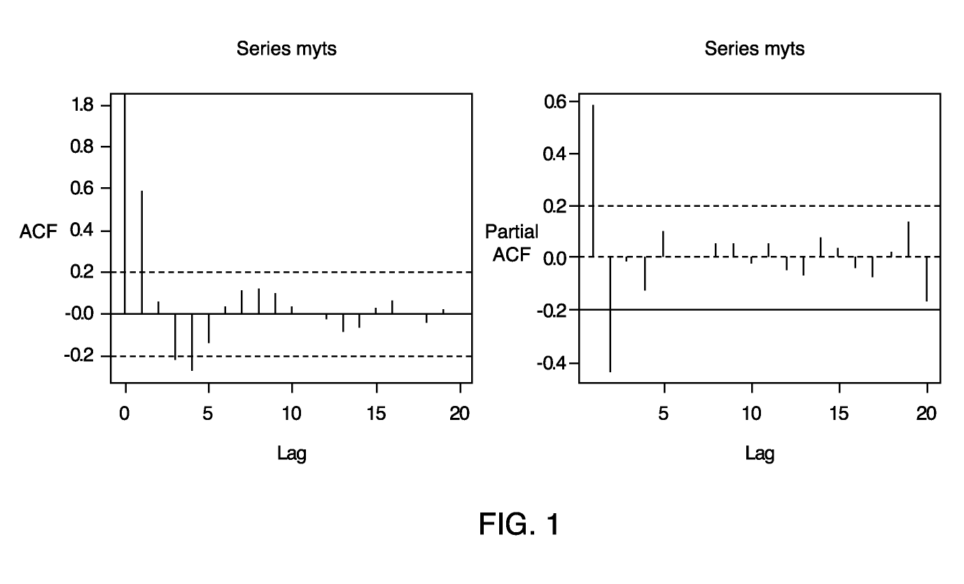

FIG. 1 is an exemplary plot of the autocorrelation function (ACF) and partial autocorrelation function (PACF) for an autoregressive model AR(2);

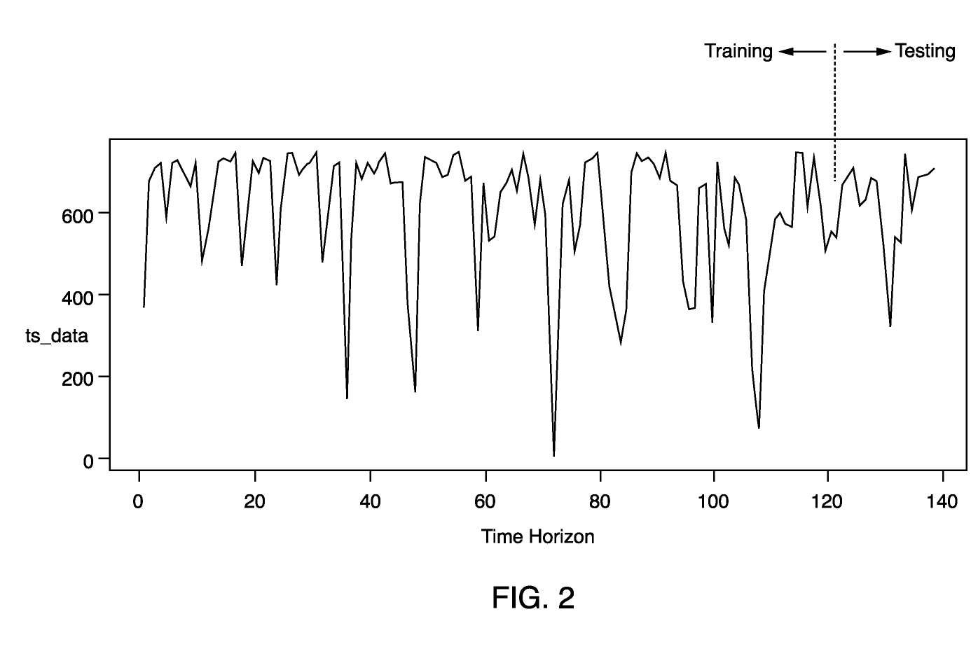

FIG. 2 is an exemplary plot of operating hours for a gas turbine, provided as a time series for evaluation in accordance with the present invention;

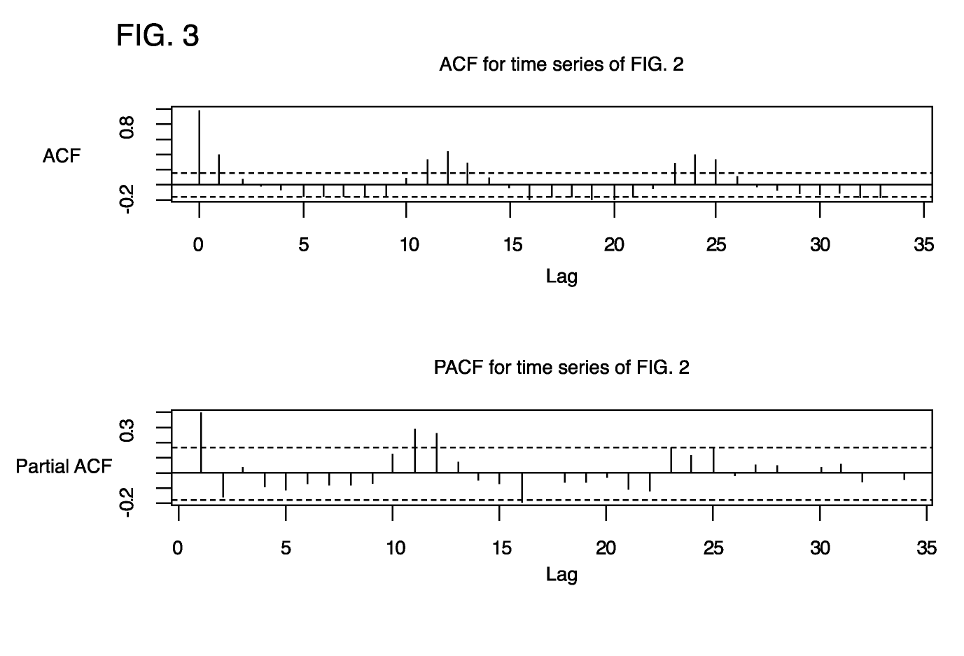

FIG. 3 includes plots of ACF and PACF for the time series of FIG. 2;

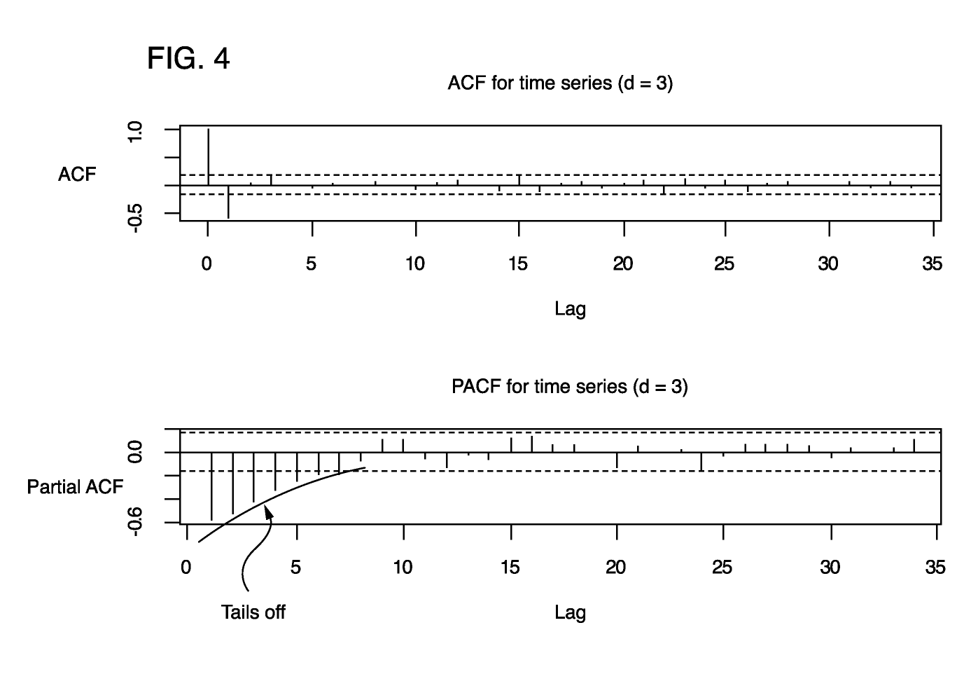

FIG. 4 includes plots of ACF and PACF after performing a set of three differencing functions (d=3) on the time series of FIG. 2;

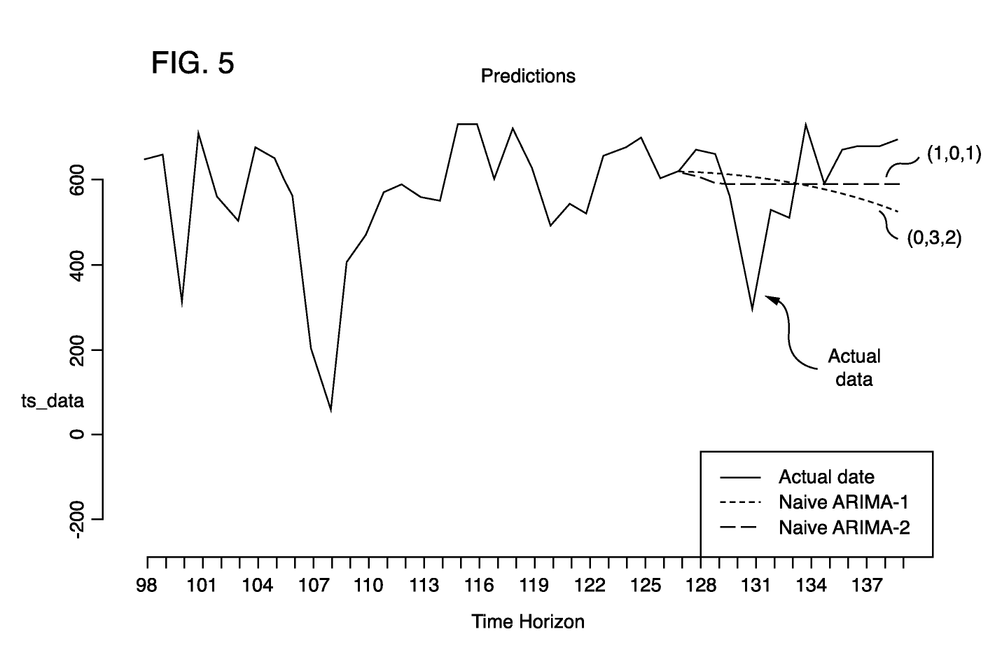

FIG. 5 contains plots of actual data, as well as two prior art naïve ARIMA models, for the “test” portion of the time series of FIG. 2;

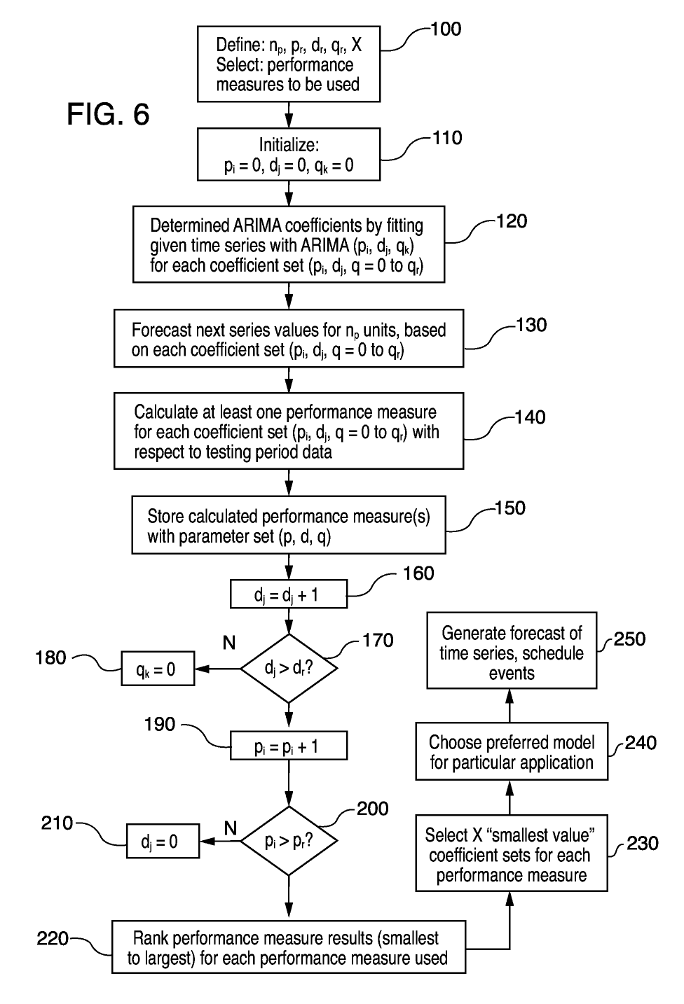

FIG. 6 is a flowchart of an exemplary process of selecting optimum ARIMA model(s) in accordance with the present invention;

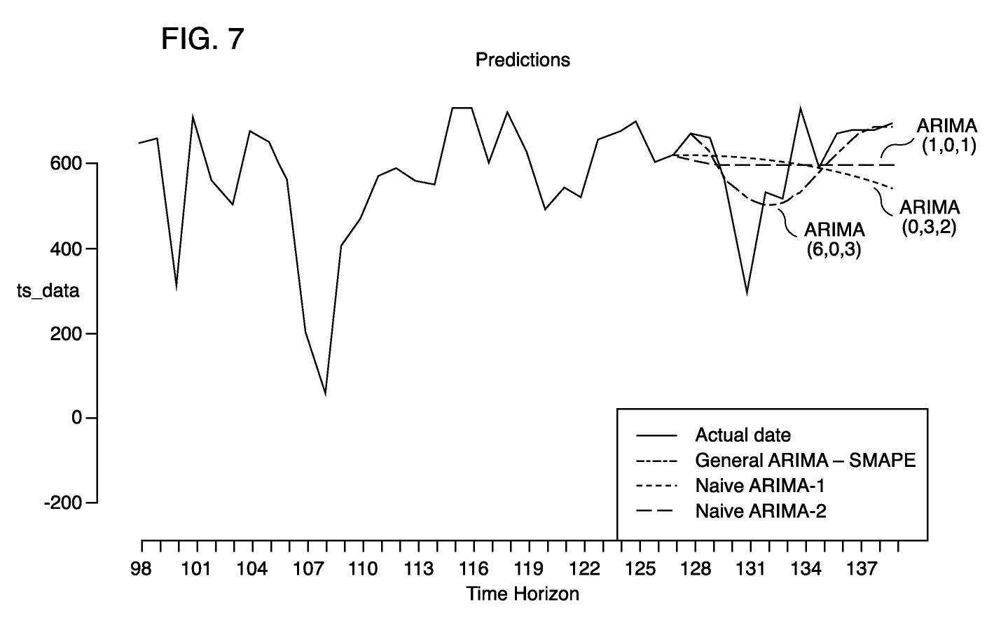

FIG. 7 contains plots of actual data (of the time series shown in the testing period of FIG. 2), prior art naïve ARIMA models, and an optimum ARIMA model (according to the SMAPE performance measure) selected using the methodology of the present invention;

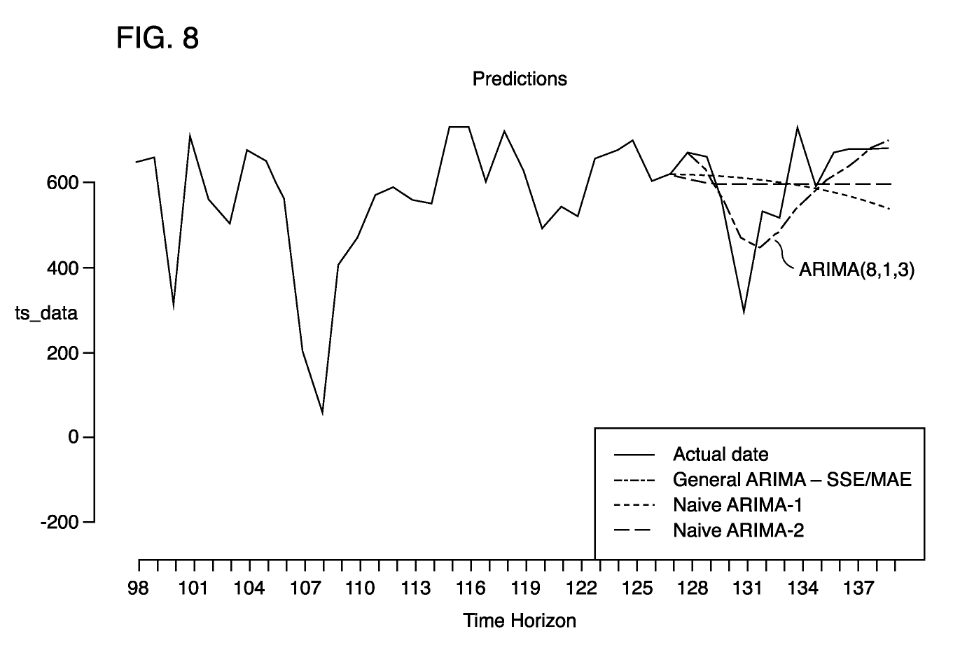

FIG. 8 contains plots of actual data (testing period of FIG. 2), prior art naïve ARIMA models, and an optimum ARIMA model (according to the SSE/MAE performance measures) selected using the methodology of the present invention;

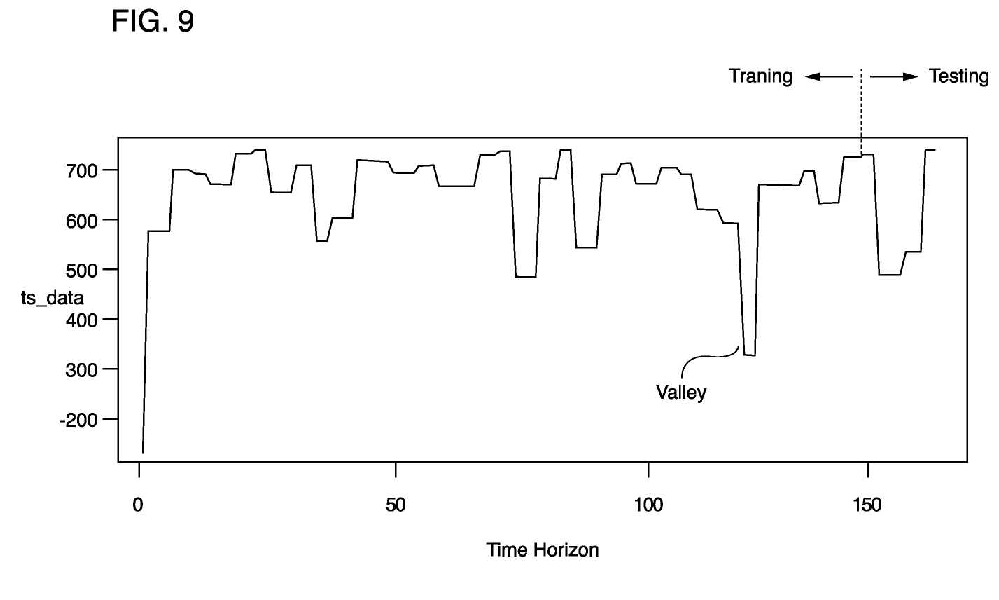

FIG. 9 is an exemplary plot of operating hours for a gas turbine (including a relatively large valley), provided as a time series for evaluation in accordance with the present invention;

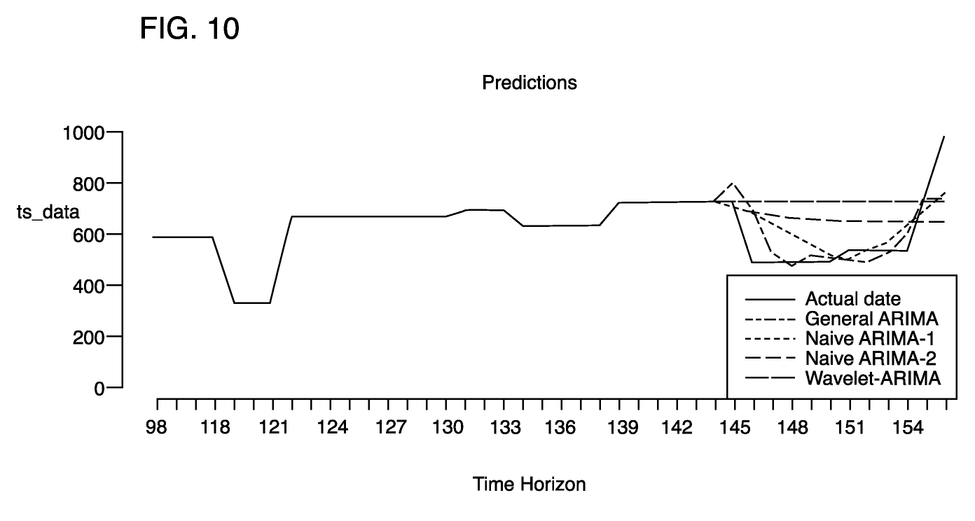

FIG. 10 contains plots of actual data (of the testing period data in the plot of FIG. 9), prior art naïve ARIMA models, an optimum ARIMA model selected using the methodology of the present invention, and an optimum wavelet-ARIMA model selected using the methodology of the present invention;

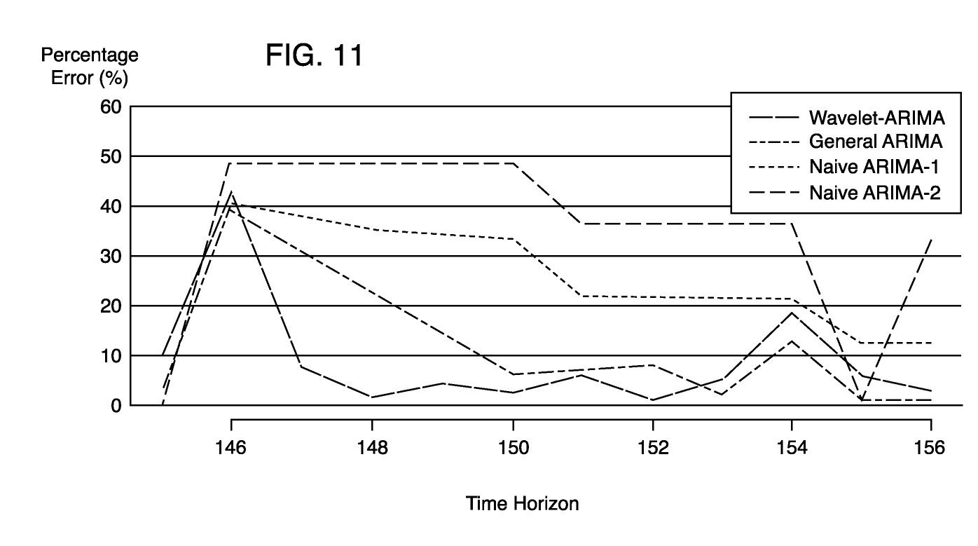

FIG. 11 is a plot of percentage errors for the prior art naïve ARIMA models, as well as the generalized ARIMA and wavelet-ARIMA models selected by using the methodology of the present invention; and

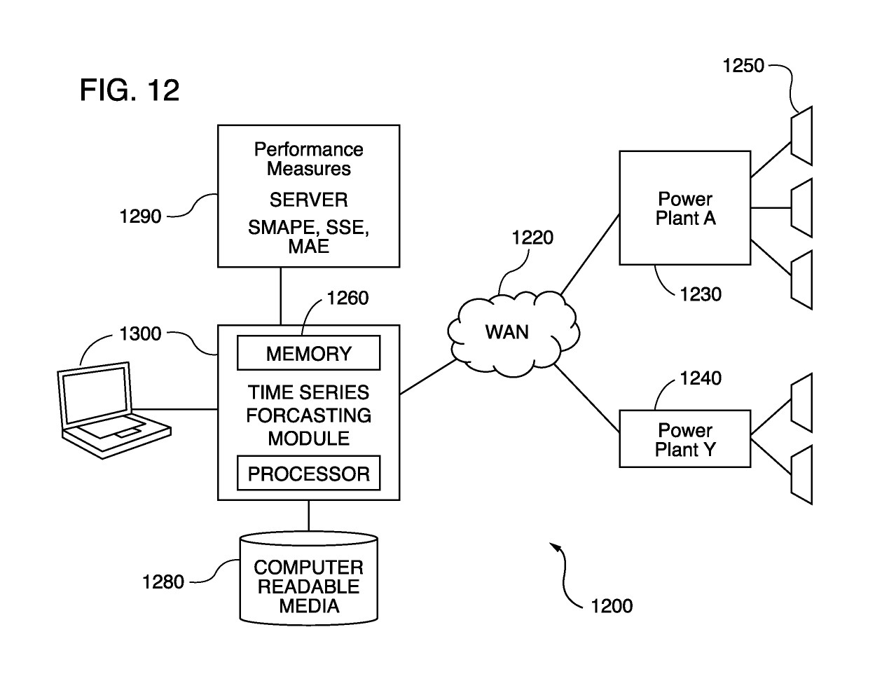

FIG. 12 is a block diagram of an exemplary system that may implement the generalized ARIMA model evaluation in accordance with the present invention.

### DETAILED DESCRIPTION

The present invention describes a methodology that is better able to perform predictive analytics of times series. While discussed below in the context of planning maintenance events for gas turbines in power plants, the overall methodology is useful in various other types of times series forecasting, such as but not limited to, electricity demand forecasting, financial forecasting, weather forecasting, etc.

The science of time series predictive analytics utilizes many acronyms, which are presented below in tabular form with their definitions. The table is presented in alphabetical order, which may differ from the order in which the acronyms appear in the text.

TABLE I

| | |
|---|---|
| ACF | autocorrelation function |
| AIC | Akaike Information Criterion |
| AICc | Akaike Information Criterion corrected (for small numbers) |
| AR | autoregressive |
| ARIMA | autoregressive integrated moving average |
| ARMA | autoregressive moving average |
| BIC | Bayesian Information Criterion |
| MA | moving average |
| MAE | mean absolute error |
| MAPE | mean absolute percentage error |
| SMAPE | symmetric mean absolute percentage error |
| SSE | sum of squares error |

In accordance with the present invention, an improved ARIMA model for use in predictive analytics of time series is based upon creating all possible ARIMA models (by knowing a priori the largest possible values of the p, d and q variables, as defined below), and utilizing the results of at least two different performance measures to ultimately choose the model that is most appropriate for the time series under study.

As mentioned above, prior art methodologies for predictive analysis of time series selects a “better” ARIMA (or ARMA) model from a set of convention prior art models. In particular, two specific types of prior art ARIMA models (referred to herein at times as na\ddot{v}e ARIMA models) are typically generated: (1) a first model based on ACF, PACF analysis; and (2) a second model based on AIC analysis (at times, using AICc or BIC instead of AIC). In many situations, neither model is considered to be a good predictor of a given time series. It is considered useful to review the basics of the naïve ARIMA approach to predictive analytics of time series, in order to best appreciate the improvements provided by the methodology of the present invention.

In statistics, the ARIMA model is a generalization of the ARMA model, which comes from a combination of the autoregressive (AR) model and the moving average (MA) model, where both of these models are considered to be efficient in fitting time series data (for either analyses of historical data, or performing forecasting based on the historical data). The notation ARMA(p,q) is associated with the ARMA model based on a set of “p” autoregressive terms and “q” moving average terms.

The autoregressive model is constructed by defining the current value xₜ of a time series as a linear function of p past values, xₜ₋₁, . . . , xₜ₋ₚ. An autoregressive model of order “p”, denoted AR(p), is defined as follows:

xₜ=φ₁xₜ₋₁+φ₂xₜ₋₂+ . . . +φₚxₚ+εₜ,

where xₜ is stationary and φ₁, φ₂, . . . , φₚ are constants (φₚ≠0). It can be assumed that εₜ˜N(o,σₜ²).

The moving average model is constructed by defining the current value xₜ of a time series as a linear function of q past averages of m values. A moving average model of order “q”, or MA(q), is defined as follows:

xₜ=εₜ+θ₁εₜ₋₁+θₜ₋₂+ . . . +θ_{q}ε_{t-q},

where there are q lags in the moving average and θ₁, θ₂, . . . , θ_{q} are the averages over m terms.

For stationary time series, the AR and MA models can be combined to form the ARMA model and the concise form of the ARMA(p,q) model can be written as:

(1−φ₁L− . . . −ₚL^{p})xₜ=α+(1+θ₁L+ . . . +θ_{q}L^{q})εₜ,

where L is the lag operator and α:=μ(1−φ₁− . . . −φₚ) with μ defined as the mean of xₜ.

As mentioned above, a typical prior art approach to determining the best p and q parameters for the AR(p) and MA(q) models was to study the ACF and PACF plots for a given time series. The ACF is defined as the difference between a given time series and the same series shifted by a given time interval. The “partial” ACF is another indicator of the time series, in this case with the stationary components removed. For the sake of discussion, the specific definitions and properties of the ACF and PACF are not described since they are not necessary for understanding the principles of the present invention. In order to understand the prior art ARMA and ARIMA models and the improvements provided by the general ARIMA methodology of the present invention, is it sufficient to understand only how ACF and PACF relate to the AR and MA models described above. The following table summarizes the behaviors of each of these functions with respect to all three AR, MA, and ARMA models:

TABLE II

| | AR(p) | MA(q) | ARMA(p, q) |
|---|---|---|---|
| ACF | tails off | cuts off after lag q | tails off |
| PACF | cuts off after lag p | tails off | tails off |

FIG. 1 illustrates the ACF and PACF results for an AR(2) model with φ1=0.9 and φ2=−0.5.

As is known in the art, the ACF and PACF are used to perform analytics on stationary time series. For time series that are non-stationary, the ARIMA model is utilized, which “integrates” the stationary component of a given time series with the non-stationary component of the same series by performing a “differencing” calculation between the two components. The order “d” appearing the ARIMA (p,d,q) model denotes the number of “differencing” processes required to yield a stationary function. In general, the ARIMA (p,d,q) model can be written as follows:

(1−φ₁L− . . . −φₚL^{p})(1−L)^{d}xₜ=α+(1+θ₁L+ . . . +θ_{q}L^{q})εₜ,

where α:=μ(1−φ₁− . . . −φₚ) and μ is defined as the mean of the series.

The prior art ARIMA (p,d,q) modeling is now described in the context of studying a time series that represents the monthly operating hours of a gas turbine at a power plant, and then predicting the future operating hours so that a “best time” for scheduling maintenance events that require disassembly of the gas turbine can be determined. There are three specific types of disassembly inspections required for gas turbines, where each involves opening the turbine for inspection of its internal components. These inspections are generally defined as: combustion inspection (CI), hot gas path (HGP) inspection, and “major” inspection. The combustion inspection is a relatively short (time-wise) disassembly shutdown inspection, concentrating on the combustion liners, transition pieces, fuel nozzles, and end caps. The hot gas path inspection includes the full scope of the combustion inspection as well as a detailed inspection of the turbine nozzles, stator shrouds, and turbine buckets. The “major” inspection aims to examine all of the internal rotating and stationary components of the turbine, from the input of the machine through its exhaust, and includes elements of both the CI and HGP inspections.

The combustion, hot gas path, and major inspections are typically performed in a periodic manner, where the specific timing of the three may vary from one turbine to another. The scheduling may also vary as a result of changes in the work environment and conditions of the machine (such as temperature, humidity, and/or age of the machine). For example, a combustion inspection may be scheduled every 8000 hours of “operation”, HGP every 16,000 hours, and a major inspection every 32,000 hours of operation. Two typical patterns of inspection are: (1) CI-HGP-CI-Major and (2) CI-CI-HGP-CI-CI-Major.

The use of ARIMA analysis of past operating hours, therefore, is a useful tool in predicting future operating hours and scheduling these disassembly maintenance events. FIG. 2 is composed of monthly operating hours for 139 months, where the most recent 12 months is defined as the in-sample “testing” data and all previous data as the in-sample “training” data. When studying various ARIMA models, the training data is used by the ARIMA to predict the “testing” data. The actual data is then compared against the predicted values using one or more performance measures to evaluate how well the model fits to the actual data.

A first naïve prior art ARIMA(p, d, q) model for performing predictive analytics on the time series of FIG. 2 uses the ACF and PACF to select the “best” values for p, d and q. The ACF and PACF graphs for the original time series of FIG. 2 are shown in FIG. 3. Neither graph shows any obvious “cuts off” or “tails off” effects, meaning that this particular time series is non-stationary. Thus, as described above, the general method to deal with this kind of time series is to “difference” the time series a number of times until obvious “cuts off” or “tails off” effects are observed in the ACF and PACF plots. FIG. 4 contains graphs of the ACF and PACF after the time series has been differenced three times (i.e., d=3). At this point, the ACF includes a “cuts off” effect and the PACF includes a “tails off” effect. This suggests that a parameter value d=3 would be appropriate to use in the ARIMA(p,d,q) model. Thus, a first model is selected as ARIMA(0,3,2) (no past values used, and only 2 moving average lag values).

Another well-known type of ARIMA(p,d,q) model uses the AIC , where this model is sometimes better for small sample sizes where the value of d needs to be minimized. The naïve ARIMA model based on AIC suggests that an ARIMA model with parameters (p,d,q)=(1,0,1) would be best.

FIG. 5 contains plots of the “in-sample testing” portion of the gas turbine operating hours time series shown in FIG. 2, as well as the naïve ARIMA(0,3,2) and naïve ARIMA(1,0,1) predictions for this same testing period. A casual, qualitative review of the plots leads to the conclusion that neither one of the naïve ARIMA models does a very good job of predicting the future time series values. Well-known performance measures may be used to quantify this conclusion, by mathematically defining how well a model fits the actual time series data. For the purposes of this discussion, the mean absolute percent error (MAPE), sum of squares error (SSE) and mean absolute error (MAE) performance measures will be used. In general, it is to be understood that various other performance measures well-known in the art may be used as well.

The MAPE is usually applied to measure the accuracy of a method for fitting time series values in statistics. In general, it is defined as a percentage as follows:

$$MAPE = \frac{1}{n} {\sum }_{t = 1}^{n} \vert \frac{{F}_{t} - {A}_{t}}{{A}_{t}} \vert ,$$

with the actual time series data value Aₜ≧0 and Fₜ being defined as the forecast value of a time series. For the purposes of this discussion, MAPE will be defined as Mₜ (with the understanding that if Aₜ+Fₜ=0, Mₜ is also defined as 0). In situations such as a study of gas turbine operating hours, there is a need to provide both a lower bound and an upper bound on the measure. This is referred to as the “symmetric MAPE” or SMAPE, which is defined as:

$$SMAPE = \frac{1}{n} {\sum }_{t = 1}^{n} {M}_{t} ,$$

SSE is defined as the measurement of the discrepancy between the actual data and an estimation model, and is defined as follows:

$$SSE = \frac{1}{n} {\sum }_{t = 1}^{n} {( {F}_{t} - {A}_{t} )}^{2} .$$

Another measure, MAE, is also a quantity used to measure how close forecasts are to the actual data, and is given by:

$$MAE = \frac{1}{n} {\sum }_{t = 1}^{n} \vert {F}_{t} - {A}_{t} \vert .$$

The definitions of these three particular performance measures suggest that the smaller values of the measures indicate a better fit of the model to the actual data. As will be discussed in detail below, these three measures are also used in evaluating the adaptive ARIMA results provided using the methodology of the present invention.

Applying these three performance measures in comparing the actual data to the naïve ARIMA results plotted in FIG. 5 yields the following results:

TABLE III

| Method | Model | SMAPE | SSE | MAE |
|---|---|---|---|---|
| ACF, PACF | ARIMA(0, 3, 2) | 0.09324573 | 205133.1 | 107.5655 |
| AIC | ARIMA (1, 0, 1) | 0.08075713 | 158651.2 | 92.6534 |

The relatively large values of each of these performance measures confirms the conclusion from the visual inspect of the data that neither of these naïve ARIMA models does a very good job of predicting the actual data.

As will be discussed in detail below, the methodologies utilized in accordance with the present invention significantly improve these performance measures (by upwards of 40%, for example) by not confining the (p,d,q) parameters to the values associated with the ACF/PACF and AIC prior art models. Rather, the method of the present invention allows each parameter to range over all possible values, and then evaluates the complete universe of all possible ARIMA models based on these combinations of p, d and q to find the specific p, d and q parameters that yield the “best” (i.e., lowest value) performance measures. The following paragraphs describe this inventive process in detail.

In the particular process described in detail below, a subset of five (5) parameter combinations for each of the three above-defined performance measures is selected for review by the personnel utilizing the time series forecasting for planning purposes. It is to be understood that any set of performance measures may be used to evaluate the models, and any subset of the complete universe of evaluated models may be selected for review, with the use of three performance measures and a subset of five parameter combinations selected for analysis considered to be for illustrative purposes only.

Before proceeding through the methodology in detail, the following notations are defined:
{xₖ}ᵢ₌₁ⁱ⁼ⁿ time series of n time units
pₙ number of time units to be forecasted
pᵣ largest possible value for p in ARIMA(p,d,q) model
dᵣ largest possible value for d in ARIMA(p,d,q) model
qᵣ largest possible value for q in ARIMA(p,d,q) model
ω wavelet transform
1∂⁻¹ inverse wavelet transform
[symbol] set of natural numbers, i.e., {1, 2, 3, . . . }
[symbol] set of real numbers

The generalized ARIMA approach of the present invention creates the ARIMA(p,d,q) results for all possible combinations of p=0 through pᵣ, d=0 through dᵣ, and q=0 through qᵣ. In the specific algorithm as shown below (and also in the more generalized flowchart of FIG. 6), the method evaluates the ARIMA models generated based on all possible combinations of p, d and q, and ranks the results of each model using selected performance measures. Each performance measure may create a slightly different ranking of “best fit” for the ARIMA models, allowing the user to select an optimum choice for a particular circumstance.

The generalized ARIMA algorithm is stated as follows (using the notation defined above):

1: Input {xₖ}ᵢ₌₁ⁱ⁼ⁿ, {nₚ, pᵣ, dᵣ, qᵣ} ⊂ {0} ∪ [symbol]
2: for i= 0 to pᵣ do
3: for j = 0 to dᵣ do
4: for k = 0 to qᵣ do
5: coef ← ARIMA coefficients by fitting {xₖ}ᵢ₌₁ⁱ⁼ⁿ with
ARIMA(i,j,k) model.
6: pred ← Forecasts for nₚ time units by ARIMA(i,j,k) model
with coefficients coef.
7: Compute SMAPE(i,j,k)
8: Compute SSE(i,j,k)
9: Compute MAE(i,j,k)
10: end for
11: end for
12: end for
13: I_{SMAPE} ← Indices of five smallest values from SMAPE
14: I_{SSE} ← Indices of five smallest values from SSE
15: I_{MAE} ←Indices of five smallest values from MAE.
return I_{SMAPE}, I_{SSE}, I_{MAE}.
end

Generally speaking, this algorithm computes the ARIMA coefficients associated with fitting each possible ARIMA model to the “training” portion of a given time series (step 5). These coefficients are then used to create a time series forecast for each possible model (step 6). All of these possible predictions of the future time series are compared to the actual time series data in the “testing” portion of the given time series, using at least one standard performance measure of “fitting error” between the actual data and the forecasted values (steps 7-9). The best results for each performance measure are then returned to the user for planning purposes (steps 13-15).

In the specific case of analyzing time series for gas turbine hours for each period, the “pred” would be non-negative. In order to be consistent with actual power plant operations, if the “pred” value calculated for any combination of coefficients results in a negative value, it is reset to 0.

This algorithm is also depicted in the flowchart of FIG. 6, albeit in a more general in form. In particular, instead of including the three “compute” functions shown in steps 7, 8 and 9, the process in the flowchart is generalized to “compute at least one performance measure”. Similarly, instead of selecting the “five smallest values” for each measure as shown in steps 13, 14 and 15, the process in the flowchart is generalized to selecting “X smallest values”.

Referring now to the flowchart in FIG. 6, step 100 is the input to the process, where the specific time series, number of units to be forecasted and the maximum possible values for p, d and q are provided. These maximum values for p, d, and q will be at the user's discretion and are determined based upon a number of factors, including the known history of the specific time series under study. For the purposes of the present invention, there is no foreseen danger in over-estimating these values (except for the computational time requirements), since the “best” fit will be associated with the smallest of the values. The specific performance measures (e.g., MAPE, SMAPE, SSE, MAE, etc.) to be used in analyzing the fit of the ARIMA models is also defined at the beginning of the process, wherein in accordance with the present invention it is preferred that at least two performance measures be evaluated.

Step 110 of the process begins by initializing all three ARIMA parameters (p,d,q) to 0. Once this has occurred, the inner-most loop begins at step 120 by sweeping the value of q from 0 to qᵣ, and determining the ARIMA coefficients associated with the training section of the time series for all (0,0,q). For each model ARIMA(0,0,qₖ), a forecasted (predicted) set of values nₚ for the testing section of the time series is units is next generated in step 130, and two or more performance measures for each of these forecasts is created in step 140. The generated performance measurements are stored and associated with each model ARIMA(0,0,qₖ) in step 150.

Once all of the ARIMA values for the (p,d) pair (0,0) has been evaluated for every value of q from 0 to qᵣ, the process continues to step 160, which increments the value of the d parameter. A check is then performance at step 170 to see if the d parameter has reached its maximum possible value. If the incremented value of d is still below its maximum possible value, the process continues to step 180, which resets the q parameter to the 0 value. The process then returns to step 130, and a new set of time series forecasts is created for ARIMA(0,1, q=0 through qᵣ), with the associated performance measures determined for each predicted time series.

At the point in time where the results of the inquiry at step 170 is that d has now exceeded its maximum possible value, the process moves to step 190, which increments the value of the “p” parameter to 1. A check is made in step 200 to determine if p has exceeded its maximum possible value pᵣ. Presuming this is not the case, the process moves to step 210, which resets the value of d to 0, and then proceeds to step 130 to re-set q to 0 and then returns the process to step 130 to analyze yet another set of ARIMA models.

Once the result of the decision at step 200 that p has now exceeded its maximum possible value, every possible combination of p, d, and q has been analyzed and at least one performance measure has been determined for each time series forecast (preferably, at least two or three different performance measures are created). The process then moves to step 220, which ranks of the stored values for each performance measure (where the smallest value is defined as the “best”). The specific ARIMA (p,d,q) models for these “best” measures are identified. Step 230 selects a subset X of the “best” results for each performance measure, and the personnel proceeds to pick a preferred model for the particular task (step 240) and then creates a scheduling/production output (step 250) based on the preferred model.

When using the process as outlined in the above algorithm and shown in the flowchart of FIG. 6, the following set of values were obtained for the gas turbine operating hours time series data as shown in FIG. 2. The results include five sets of (p,d,q) values that generate the smallest values for each of the three selected performance measures. The five are “ranked” for each performance measure, with the number 1 ranking associated with the smallest calculated value of the associated performance measure.

TABLE IV

| ranking | 1 | 2 | 3 | 4 | 5 |
|---|---|---|---|---|---|
| (p, d, q) | (6, 0, 3) | (8, 1, 3) | (7, 1, 4) | (11, 0, 6) | (7, 0, 8) |
| SMAPE | 0.0483542 | 0.0487051 | 0.0487064 | 0.0501322 | 0.0501351 |
| (p, d, q) | (8, 1, 3) | (7, 1, 4) | (7, 2, 9) | (5, 0, 3) | (11, 0, 7) |
| SSE | 77768.8 | 80403.1 | 88098.2 | 89325.8 | 89760.4 |
| (p, d, q) | (8, 1, 3) | (6, 0, 3) | (7, 1, 4) | (11, 0, 6) | (6, 0, 9) |
| MAE | 51.5114 | 51.6045 | 52.5196 | 54.0659 | 53.1992 |

For this specific time series, the ARIMA(6,0,3) model yields the best SMAPE performance measure, while the ARIMA(8,1,3) model is associated with the best SSE and MAE performance measures. Personnel using these various predictive analytics tools can select one or the other to use (or perhaps one of the other models listed in Table IV), depending on other factors, personal preference, etc. as a “preferred” model for the personnel's purposes. In comparing these results to those associated with the naïve ARIMA model (Table II), it is clear that the generalized ARIMA approach of the present invention yields an improvement in performance estimation by more than 40%.

For comparison purposes, FIG. 7 contains plots of the actual data (from the in-sample testing portion of the gas turbine operating hours time series plot of FIG. 2), as well as the models created by the two prior art naïve ARIMA models (ARIMA(3,0,2) and ARIMA(1,0,1)) and the “top-ranked” SMAPE model ARIMA(6,0,3) determined in accordance with the present invention. FIG. 8 contains similar plots, but in this case comparing the actual data and the prior art results to the ARIMA(8,1,3) model identified by the process of the present invention as the “top-ranked” by both the SSE and MAE measures. It is clear from both FIGS. 7 and 8 that the generalized ARIMA methodology of the present invention is much better than the naïve ARIMA models of the prior art in identifying the trend of time series such as operating hours of gas turbines.

Some time series forecasting problems are not easy to deal with. For example, in series that include special structures (such as large, infrequent peaks and/or valleys), the generalized ARIMA process as discussed above may not be able to identify these structures and incorporate their effects in the modeling. One approach to improve the forecasting results involves decomposing the historical data in the time series, and attempt to identify trends by performing separate ARIMA modeling on each decomposed component. This is also referred to in the art, at times, as “wavelet” ARIMA.

There are many types of wavelets used in various types of statistical modeling. For the purposes of the present discussion the Daubechies wavelet of order 5 is used, where the order refers to the number of the vanishing moments. This particular wavelet was selected since it offers an appropriate trade-off between wavelength and smoothness. Another important parameter of the Daubechies wavelet transform is the number of levels. At each level, the series will be decomposed into “low” and “high” frequencies. Since a decomposition process is being used, the length of the original time series must be a multiple of 2^{LE} where LE is the number of levels.

The wavelet-ARIMA model works by adding a decomposition process and inverse decomposition process to the ARIMA algorithm as defined above. The decompositions are made by using wavelet transforms. An exemplary wavelet-ARIMA algorithm is defined as follows:

```
1: Input {xₖ}ᵢ₌₁ⁱ⁼ⁿ, {nₚ, pᵣ, dᵣ, qᵣ} ⊂ {0} ∪ [symbol]
2: Apply the wavelet transform to the training part of the time series
{xₖ}ᵢ₌₁ⁱ⁼ⁿ⁻ⁿₚ to get LE+1
    series denoted by ts₁, ..., ts_{LE+1} ∈ [symbol]   ^{n-np} , i.e., [symbol]
    ({xₖ}ᵢ₌₁ⁱ⁼ⁿ⁻ⁿ^{ₚ}) := {ts₁, ..., ts_{LE+1}}
3: for i= 0 to pᵣ do
4: for j = 0 to dᵣ do
5: for k = 0 to qᵣ do
6: for [symbol]   = 0 to LE+1 do
5: [symbol]   ← ARIMA coefficients by fitting [symbol]   ∈ [symbol]   ^{n-np} with
        ARIMA(i,j,k) model.
6: [symbol]   ← Forecasts for nₚ time units by ARIMA(i,j,k) model
with coefficients [symbol]    .
9: end for
10: Apply the inverse wavelength transform to get the
          predictions:
              pred ← [symbol]  (pred₁, ..., pred_{LE}).
11: Compute SMAPE(i,j,k)
12: Compute SSE(i,j,k)
13: Compute MAE(i,j,k)
14: end for
15: end for
16: end for
17: I_{SMAPE} ← Indices of five smallest values from SMAPE
18: I_{SSE} ← Indices of five smallest values from SSE
19: I_{MAE} ←Indices of five smallest values from MAE.
  return I_{SMAPE}, I_{SSE}, I_{MAE}.
end
```

In order to analyze the improvements associated with using this wavelet-ARIMA approach, the time series as shown in FIG. 9 was analyzed, where the time series is shown to include a “special structure” in terms of a large valley (in terms of operating hours) between the 118 and 121 hours of service for a given gas turbine. When processing the time series of FIG. 9 through the wavelet-ARIMA algorithm as shown above, the results as presented in Table V were generated. For comparison, the generalized ARIMA approach was also utilized, as well as the two naïve ARIMA models. Here, only the “best” models (instead of the top 5 best results) are shown. Since the three performance measures select the same best model for both the generalized ARIMA and the wavelet-ARIMA approaches, only one model is displayed for each of the measures in Table V, below.

TABLE V

| Methods | ARIMA models | SMAPE | SSE | MAE |
|---|---|---|---|---|
| Naïve ARIMA | (0, 1, 2) | 0.135133 | 434451.6 | 166.5817 |
| (ACF/PACF) | | | | |
| Naïve ARIMA | (3, 0, 2) | 0.1165695 | 256232.8 | 139.7132 |
| (AIC) | | | | |
| General ARIMA | (2, 6, 7) | 0.0681495 | 147517.0 | 83.1290 |
| Wavelet-ARIMA | (1, 3, 7) | 0.0422049 | 65143.1 | 50.1671 |

As clear from the results shown in Table V, the wavelet-ARIMA model out-performs the general ARIMA method when the time series includes these peak/valley features (in general, “special structures”). In particular, the decomposition of the series and use of wavelets gives the possibility of catching trends and incorporating their effects. The corresponding graph of the “actual data” (from FIG. 9) and the various predictions is shown in FIG. 10.

A method of quantifying the improvement in time series prediction when using the general ARIMA (or wavelet-ARIMA) of the present invention is found by checking the percentage errors of every month for all models, where the percentage error (PE) at each time t is defined as:

$${PE}_{t} = \vert \frac{{F}_{t} - {A}_{t}}{{A}_{t}} \vert .$$

FIG. 11 is plot of the percentage errors for the models as shown in Table V. The PE values result that most of the PEs of the wavelet-ARIMA model fall into 10% and around half of the PEs of the general ARIMA model are within 10%. However, PEs of the two naïve ARIMA models are rarely less than 10%.

The elements of the methodology as described above may be implemented in a computer system comprising a single unit, or a plurality of units linked by a network or a bus. An exemplary system 1200 is shown in FIG. 12.

A time series forecasting module 1210 may be a mainframe computer, a desktop or laptop computer or any other device capable of processing data. Time series forecasting module 1210 receives data from any number of data sources that may be connected to the module, including a wide area data network (WAN) 1220. For example, time series forecasting module 1210 may receive gas turbine operating hours data from a first power plant 1230 via WAN 1220. Similarly, module 1210 may receive data from a second power plant 1240, also via WAN 1220. The data would carry identification information associated with the specific power plant sending the data, as well as the specific gas turbine (shown as elements 1250 in FIG. 12) from which the operating hours data was collected. A memory unit 1260 in time series forecasting module 1210 may be used to store the information linking specific identification codes with specific turbines. Additionally, memory unit 1260 may be used to store the results of the set of ARIMA model measures created by the process of the present invention.

The steps required to perform the algorithm may be included in one or more processors 1270, which may form a central processing unit (CPU). Processor 1270, when configured using software according to the present disclosure, includes structures that are configured for performing one or more methods of generalized ARIMA model checking as discussed herein.

Memory unit 1260 may include a random access memory (RAM) and a read-only memory (ROM). The memory may also include removable media such as a disk drive, tape drive, memory card, etc., or a combination thereof. The RAM functions as a data memory that stores data used during execution of programs in processor 1270; the RAM is also used as a program work area. The various performance measures used in the process of the present invention may reside in a separate server 1290, accessed by module 1210 as necessary. The ROM functions as a program memory for storing a program executed in processors 1270. The program may reside on the ROM or on any other tangible or non-volatile computer-readable media 1280 as computer readable instructions stored thereon for execution by the processor to perform the methods of the invention. The ROM may also contain data for use by the program or by other programs.

The individual personnel using the methodology of the present invention may input commands to system 1200 via an input/output device 1300, which may be directed connected to module 1210, or connected via WAN 1220 to module 1210.

The above-described method may be implemented by program modules that are executed by a computer, as described above. Generally, program modules include routines, objects, components, data structures and the like that perform particular tasks or implement particular abstract data types. The term “program” as used herein may connote a single program module or multiple program modules acting in concert. The disclosure may be implemented on a variety of types of computers, including personal computers (PCs), hand-held devices, multi-processor systems, microprocessor-based programmable consumer electronics, network PCs, mini-computers, mainframe computers, and the like. The disclosure may also be employed in distributed computing environments, where tasks are performed by remote processing devices that are linked through a communications network. In a distributed computing environment, modules may be located in both local and remote memory storage devices.

An exemplary processing module for implementing the inventive methodology as described above may be hard-wired or stored in a separate memory that is read into a main memory of a processor or a plurality of processors from a computer-readable medium such as a ROM or other type of hard magnetic drive, optical storage, tape or flash memory. In the case of a program stored in a memory media, execution of sequences of instructions in the module causes the processor to perform the process steps described herein. The embodiments of the present disclosure are not limited to any specific combination of hardware and software and the computer program code required to implement the foregoing can be developed by a person of ordinary skill in the art.

The term “computer readable medium” as employed herein refers to any tangible machine-encoded medium that provides or participates in providing instructions to one or more processors. For example, a computer-readable medium may be one or more optical or magnetic memory disks, flash drives and cards, a read-only memory or a random access memory such as a DRAM, which typically constitutes the main memory. Such media excludes propagated signals, which are not tangible. Cached information is considered to be stored on a computer-readable medium. Common expedients of computer-readable media are well-known in the art and need not be described in detail here.

Summarizing, the general ARIMA method of the present invention functions by reviewing every possible ARIMA model (that is, every possible combination of p, d, and q) and chooses the best models based on different performance measures. This ensures that the selected models would also be the preferred among the universe of all possible ARIMA models. The improvements over naïve ARIMA models are significant.

What is claimed is:

1. A method of scheduling events for industrial equipment using an autoregressive integrated moving average (ARIMA) model for predicting future operating hours based on a times series of past operating hours of the industrial equipment, comprising defining a maximum possible value for each parameter p, d, q of an ARIMA(p,d,q) model, p defining a number of autoregressive terms to include in the ARIMA model, d defining a number of differencing operations to perform in the ARIMA model, and q defining a number of moving average terms to include in the ARIMA model, the maximum possible values identified as pᵣ, dᵣ, and qᵣ;
for all possible combinations of p from 0 to pᵣ, d from 0 to dᵣ, and q from 0 to qᵣ, performing the following steps:
determining a set of ARIMA coefficients associated with a training interval of the time series;
predicting a set of N future hours based on the determined coefficients;
computing at least one performance measure of the predicted set of N future operating hours with respect to actual time series data; and
ranking all possible combinations of ARIMA(p,d,q) based on the computed performance measures;
selecting a preferred set of (p, d, q) parameters based on the ranking;
generating a predicted future time series of industrial operating hours using the selected ARIMA(p,d,q) model; and
scheduling events based on the predicted future operating hours.

2. The method of claim 1, wherein the at least one performance measure is selected from the group consisting of: MAPE, SMAPE, MAE, and SSE.

3. The method of claim 1, wherein at least two different performance measures are computed for each possible ARIMA model.

4. The method of claim 1, wherein the ranking step creates a listing of all possible ARIMA models from the smallest value to the largest value of performance measure, for each computed performance measure.

5. The method of claim 1, wherein the ARIMA(p,d,q) model used in the analysis is the wavelet-ARIMA(p,d,q) model.

6. The method of claim 5, wherein the wavelet-ARIMA(p,d,q) module used in the analysis is the Daubechies wavelet transform.

7. A computer program product comprising a non-transitory computer readable recording medium having recorded thereon a computer program comprising instructions for, when executed on a computer, instructing said computer to perform a method for scheduling events associated with industrial equipment, using an autoregressive integrated moving average (ARIMA) model for predicting future operating hours based on past operating hours of the industrial equipment, comprising
defining a maximum possible value for each parameter p, d, q of an ARIMA(p,d,q) model, p defining a number of autoregressive terms to include in the ARIMA model, d defining a number of differencing operations to perform in the ARIMA model, and q defining a number of moving average terms to include in the ARIMA model, the maximum possible values identified as pᵣ, dᵣ, and qᵣ;
for all possible combinations of p from 0 to pᵣ, d from 0 to dᵣ, and q from 0 to qᵣ, performing the following steps:
determining a set of ARIMA coefficients associated with a training interval of the time series;
predicting a set of N future hours based on the determined coefficients;
computing at least one performance measure of the predicted set of N future operating hours with respect to actual time series data; and
ranking all possible combinations of ARIMA(p,d,q) based on the computed performance measures;
selecting a preferred set of (p, d, q) parameters based on the ranking;
generating a predicted future time series of industrial operating hours using the selected ARIMA(p,d,q) model; and
scheduling events based on the predicted future operating hours.

8. The computer program product of claim 7, wherein the at least one performance measure is selected from the group consisting of: MAPE, SMAPE, MAE, and SSE.

9. The computer program product of claim 7, wherein at least two different performance measures are computed for each possible ARIMA model.

10. The computer program product of claim 7, wherein the ranking step creates a listing of all possible ARIMA models from the smallest value to the largest value of performance measure, for each computed performance measure.

11. The computer program product of claim 7, wherein the ARIMA(p,d,q) model used in the analysis is the wavelet-ARIMA(p,d,q) model.

12. The computer program product of claim 11, wherein the wavelet-ARIMA(p,d,q) module used in the analysis is the Daubechies wavelet transform.

13. A method of scheduling gas turbine maintenance events using an autoregressive integrated moving average (ARIMA) model for predicting future gas turbine operating hours based on a times series of past operating hours of the gas turbine, comprising
defining a maximum possible value for each parameter p, d, q of an ARIMA(p,d,q) model, p defining a number of autoregressive terms to include in the ARIMA model, d defining a number of differencing operations to perform in the ARIMA model, and q defining a number of moving average terms to include in the ARIMA model, the maximum possible values identified as pᵣ, dᵣ, and qᵣ;
for all possible combinations of p from 0 to pᵣ, d from 0 to dᵣ, and q from 0 to qᵣ, performing the following steps:
determining a set of ARIMA coefficients associated with a training interval of the time series;
predicting a set of N future operating hours based on the determined coefficients;
computing at least one performance measure of the predicted set of N future operating hours with respect to actual time series data; and
ranking all possible combinations of ARIMA(p,d,q) based on the computed performance measures;
selecting a preferred set of (p, d, q) parameters based on the ranking;
generating a predicted future time series of gas turbine operating hours using the selected ARIMA(p,d,q) model; and
scheduling gas turbine maintenance events based on the predicted future time series of gas turbine operating hours.

14. The method as defined in claim 13 wherein the scheduled maintenance inventions comprises a set of disassembly maintenance events, each disassembly maintenance event to be scheduled after a predetermined number of operating hours.

15. The method as defined in claim 14 where the set of disassembly maintenance events includes a combustion inspection, hot gas path inspection and a major inspection.

16. The method as defined in claim 15 wherein the combustion inspection is scheduled more frequently than the hot gas path inspection, which is scheduled more frequently than the major inspection.

17. The method as defined in claim 16 wherein the combustion inspection is scheduled about every 8000 operating hours of the gas turbine, the hot gas path inspection is scheduled ever 16,000 operating hours, and the major inspection is scheduled every 32,000 operating hours.

18. The method of claim 13, wherein the at least one performance measure is selected from the group consisting of: MAPE, SMAPE, MAE, and SSE.

19. The method of claim 13, wherein at least two different performance measures are computed for each possible ARIMA model.

20. The method of claim 13, wherein the ARIMA(p,d,q) model used in the analysis is the wavelet-ARIMA(p,d,q) model.

21. The method of claim 20, wherein the wavelet-ARIMA(p,d,q) module used in the analysis is the Daubechies wavelet transform.
